(19) United States
(12) Patent Application Publication
(10) Pub. No.: US 2007/0145702 A1
(43) Pub. Date: Jun. 28, 2007

(54) Trailer suspension with aluminum components

(76) Inventor: Howard D. Booher, Atwater, OH (US)

Correspondence Address: FAY SHARPE LLP, 1100 SUPERIOR AVENUE, SEVENTH FLOOR, CLEVELAND, OH, 44114, US

(21) Appl. No.: 11/522,030

(22) Filed: Sep. 15, 2006

Related U.S. Application Data
(60) Provisional application No. 60/717,705, filed on Sep. 16, 2005.

(51) Int. Cl. B60G 9/00

(52) U.S. Cl. 280/124.116

(57) ABSTRACT

A trailer suspension subassembly includes an extruded aluminum mounting plate. An extruded aluminum hanger is connected to a lower face of the mounting plate. The hanger includes a trailing arm channel and a shock absorber channel. The mounting plate includes an open channel adapted to receive a trailer beam flange and a platform adjacent the open channel. The subassembly can be incorporated into a suspension assembly including a first and second hangers connected to first and second mounting plates which are connected to the lower flanges of first and second trailer beams. One or more cross plates extend between the trailer beams and are connected to the first and second mounting plates. Thee suspension assembly includes trailing arms that are optionally defined from aluminum, e.g., two or more aluminum extrusions that are interconnected by welding.

### CROSS-REFERENCE TO RELATED APPLICATION

This application claims priority from and benefit of the filing date of U.S. provisional application Ser. No. 60/717,705 filed Sep. 16, 2005, and the disclosure of said provisional application Ser. No. 60/717,705 is hereby expressly incorporated by reference into the present specification.

### BACKGROUND

Trailer suspension components, including the hangers for trailing arms of air suspensions, have traditionally been fabricated from steel, i.e., iron alloys. The popularity of steel suspension components has been driven by cost, ease of manufacture, low concern of weight and fuel consumption, and tradition. Steel suspension components for trailers exhibit numerous deficiencies.

A primary concern with steel suspension hangers and other steel suspension components is corrosion. New ice and snow control techniques have exacerbated the corrosion of conventional steel hangers and suspension components and also appear to act as a catalyst to the damaging electrolysis reaction between steel suspension components and aluminum alloy (referred to simply as “aluminum” herein) components of the trailer chassis. These new ice and snow control techniques include use of liquid compounds comprising magnesium chloride or calcium chloride that are many times more corrosive to steel as compared to “road salt” as we know it, e.g., sodium chloride. These new techniques are becoming more popular due to a cost advantage and are causing extensive damage to steel components of truck trailers. This phenomenon is documented in the article “Corrosion Explosion” appearing in the September 2004 issue of Trailer/Body Builders, pps. 38-45. Corrosion of conventional steel suspension hangers and other components exposed to these increasingly popular ice/snow control compounds will accelerate and render same unusable and/or unsafe.

Another problem associated with use of steel hangers and other steel suspension components on an aluminum trailer chassis is the resulting galvanic or “electrolysis” reaction that occurs between these dissimilar materials in the presence of an electrolyte, e.g., when wet by humidity or rain water. This reaction speeds corrosion at the interface of the dissimilar metals due to ion exchange and can lead to severe pitting and failure. In some cases, the corrosion can occur in a joint or seam which makes detection difficult.

Aluminum suspension hangers are known and available commercially from EAST MANUFACTURING CORPORATION, Randolph, Ohio. U.S. Pat. No. 6,890,003 (May 10, 2005) entitled “Suspension Subframe Assembly” is hereby expressly incorporated by referenced into this specification and discloses aluminum hangers and a suspension subframe assembly for a trailer suspension including the hangers. U.S. Patent Application Publication No. 2004/0090059 (May 13, 2004), also expressly incorporated by reference into the present specification, discloses aluminum hangers for a trailer suspension and use of a trailer mounting plates for securing the aluminum hangers to the trailer chassis.

### SUMMARY

In accordance with one aspect of the present development, a trailer suspension assembly includes first and second spaced-apart trailer beams. The first and second trailer beams include respective first and second lower flanges. At least one cross-plate extends between the first and second trailer beams. First and second mounting plates are connected to the first and second lower flanges, respectively. The first and second mounting plates are also connected to the at least one cross-plate. First and second hangers are connected to the first and second mounting plates, respectively. The first and second hangers each include a trailing arm channel adapted to receive a trailing arm end and a shock absorber channel adapted to receive a shock absorber end.

In accordance with another aspect of the present development, a trailer suspension subassembly includes an extruded aluminum mounting plate and an extruded aluminum hanger connected to a lower face of the mounting plate. The hanger includes a trailing arm channel and a shock absorber channel. The mounting plate includes an open channel adapted to receive a trailer beam flange and a platform adjacent the open channel.

In accordance with another aspect of the present development, a hanger mounting plate for a trailer suspension includes a one-piece extruded aluminum member including: (i) an upwardly open channel adapted to receive an associated trailer beam flange, the channel having a bottom wall; (ii) a platform located adjacent the channel and elevated relative to the bottom wall; and, (iii) a lower face adapted for being connected to an associated suspension hanger.

### BRIEF DESCRIPTION OF THE DRAWINGS

The present trailer suspension with aluminum components is described herein with reference to the drawings wherein:

FIG. 1 is a side elevational view of a trailer including a trailer suspension with aluminum components in accordance with the present development;

FIG. 1A is a partial isometric view as taken along view line “A” of FIG. 1 and shows the trailer suspension of the present development for one of the axles (with the wheel/tire assemblies removed);

FIG. 2 is a view as taken along line 2-2 of FIG. 1, with the trailer cargo platform not shown to reveal the underlying trailer beams and suspension components (the wheel/tire assemblies are shown schematically in broken lines);

FIG. 3 is a view as taken along line 3-3 of FIG. 1 (with the trailer cargo platform and the wheel/tire assemblies not shown);

FIG. 4 is a side elevational view as taken along line 4-4 of FIG. 3;

FIG. 5 is an isometric view of an aluminum suspension frame subassembly formed in accordance with the present development;

FIGS. 6, 7 and 8 are respective top, front and side views of the aluminum frame subassembly of FIG. 5;

FIG. 7A is a sectional view of a cross-plate as taken along line A-A of FIG. 7;

FIG. 7B is a sectional view of the aluminum frame subassembly as taken along line B-B of FIG. 7;

FIGS. 8A and 8B are front and side elevational views of the driver side mounting plate and hanger subassembly (the passenger side mounting plate and hanger subassembly is a mirror image);

FIGS. 9A, 9B, 9C and 9D are respective isometric, bottom, side and rear views of the passenger (right) side aluminum hanger of the frame subassembly shown in FIG. 5;

FIGS. 9E and 9F are respective isometric and bottom views of the passenger (right) side aluminum hanger of FIGS. 9A-9D, including a stainless steel wear liner;

FIGS. 10A, 10B, 10C and 10D are respective isometric, bottom, side and rear views of the driver (left) side aluminum hanger of the frame subassembly shown in FIG. 5;

FIG. 11A shows a profile of an aluminum extrusion workpiece from which the passenger and driver hangers of FIGS. 9A and 10A are defined;

FIG. 11B is an isometric view of the extruded aluminum workpiece of FIG. 11A;

FIGS. 12A, 12B, 12C and 12D are respective isometric, top, end (front/rear) and side views of an aluminum mounting plate of the frame subassembly shown in FIG. 5 (the driver and passenger side mounting plates are identical but arranged in opposite orientation relative to each other).

### DETAILED DESCRIPTION

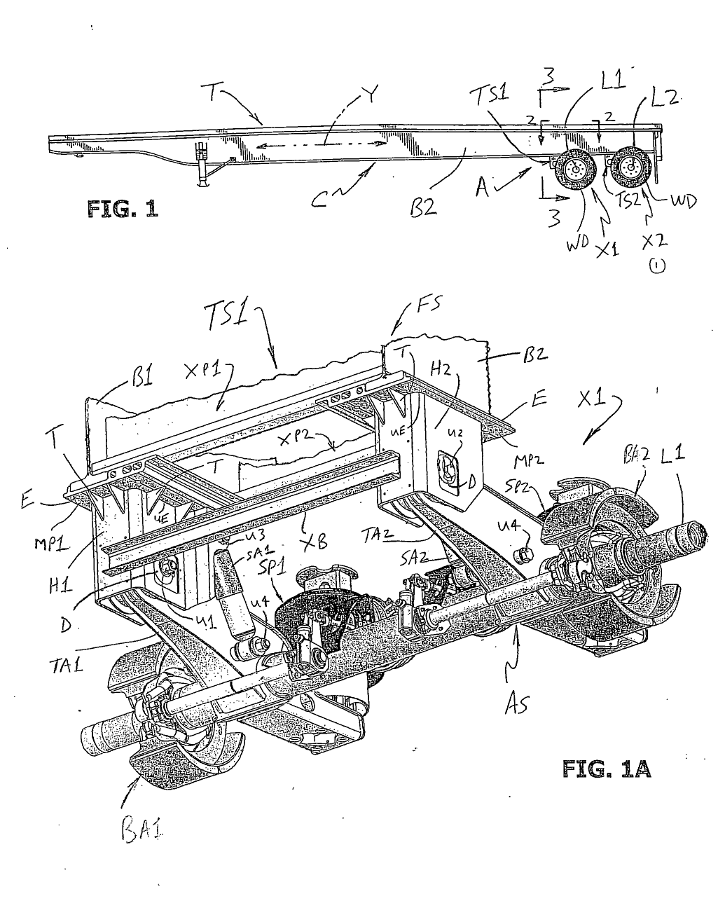

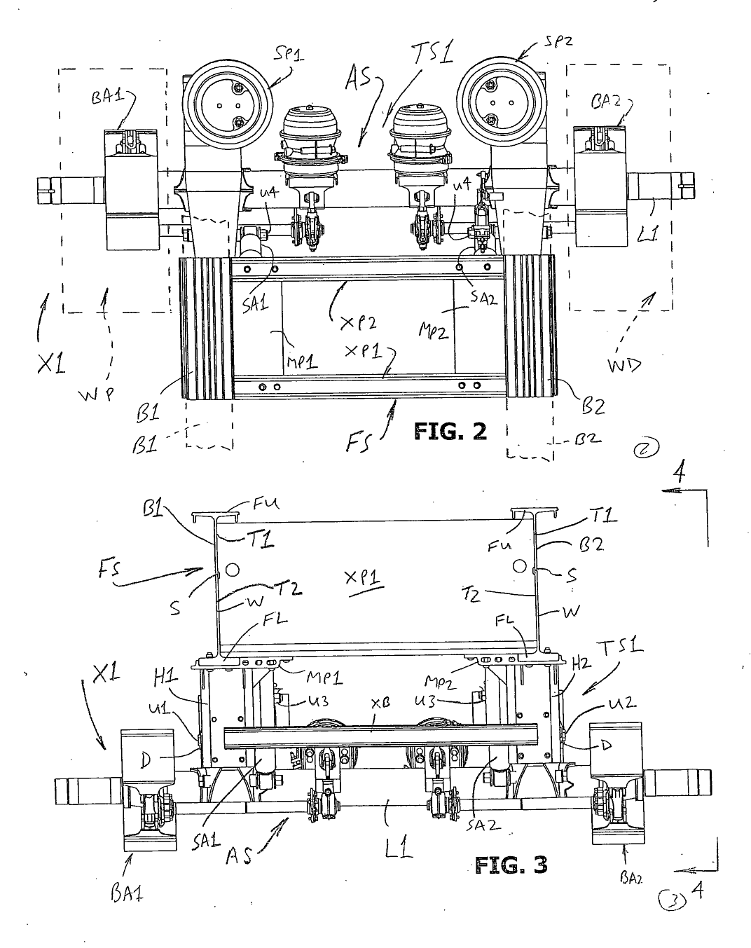

FIG. 1 shows a trailer T for a truck such as an over-the-road “semi” truck or the like. The trailer T comprises a frame or chassis C that includes first and second spaced-apart parallel beams B1,B2 (see also FIG. 1A) that extend parallel to the longitudinal axis Y of the trailer T. As shown, the beams B1,B2 extend the full axial length of the trailer T for the illustrated flat-bed or platform trailer, but they can be shorter depending upon the type of trailer, e.g., a van trailer or certain bulk commodity carriers. The trailer T comprises one or more axle assemblies X1,X2 connected to the chassis C. Each axle assembly X1,X2 comprises at least one rotatable wheel/tire assembly WD on the driver side and at least one other rotatable wheel/tire assembly WP (see FIG. 2) on the passenger side of the trailer T. The axle assemblies X1,X2 comprise respective transverse axles L1,L2 that rotatably support the wheel/tire assemblies WD,WP.

The axle assemblies X1,X2 comprises respective trailer suspension assemblies TS1,TS2 constructed with aluminum components in accordance with the present development. Insofar as the present patent specification is concerned, the trailer suspension assemblies TS1,TS2 are identical and further reference to the trailer suspension assembly TS2 is not made herein. Also, it will be recognized by those of ordinary skill in the art that a trailer T can comprise one, two or more trailer suspension assemblies TS1,TS2 as dictated by the number of axles X1,X2 or other factors.

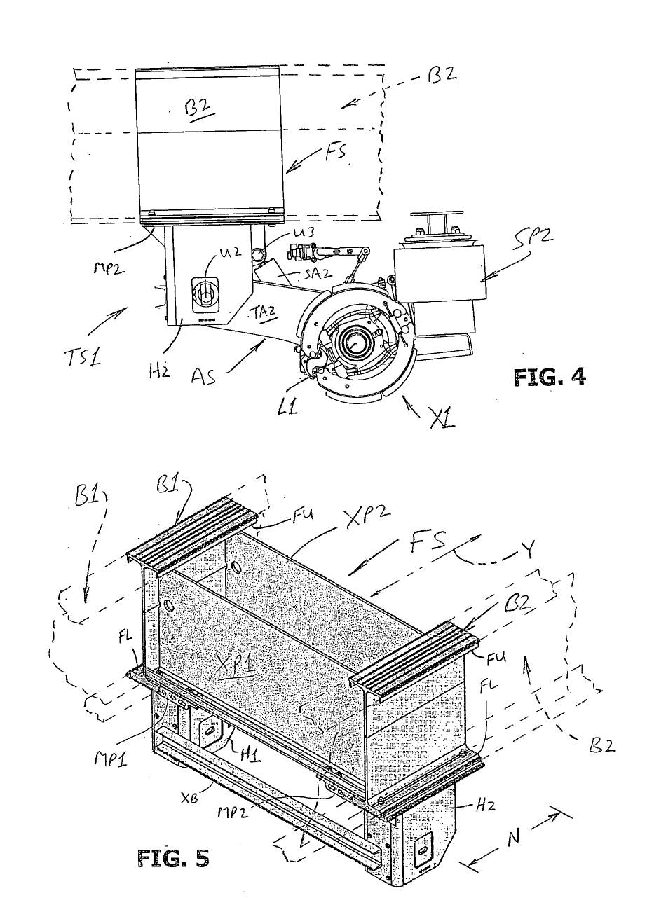

FIG. 1A is a partial isometric view of the trailer suspension assembly TS1 as taken along view line “A” of FIG. 1, and shows the relevant portions of the first and second parallel trailer beams B1,B2 (those of ordinary skill in the art will recognize that the beams B1,B2 are only partially shown and that the beams B1,B2 extend forward and rearward along the trailer axis Y further than shown in FIG. 1A). FIGS. 2, 3 and 4 also show the trailer suspension assembly TS1. With specific reference to FIGS. 1A and 2-4, in the broadest terms, the trailer suspension assembly TS1 comprises two main portions: (i) a frame subassembly FS; and, (ii) an axle subassembly AS.

The frame subassembly FS comprises the first and second spaced-apart parallel trailer beams B1,B2 (as used herein, the term “parallel” includes exactly parallel and minor variations therefrom resulting from manufacturing tolerances); first and second cross-plates XP1,XP2 that extend between and interconnect the beams B1,B2; first and second mounting plates MP1,MP2 connected respectively to the beams B1,B2; and, first and second hangers H1,H2 connected respectively to the first and second mounting plates MP1,MP2. The frame subassembly FS typically further comprises a cross brace XB that extends directly between and interconnects the hangers H1,H2, by being welded or otherwise affixed to the hangers H1,H2. For ease of reference, the frame subassembly FS is shown separately in FIGS. 5-8.

The second main portion of the trailer suspension assembly TS1, i.e., the axle subassembly AS, comprises the axle L1 and components connected thereto such as the brake assemblies BA1,BA2; air spring assemblies SP1,SP2 (which also connect respectively to the beams B1,B2); trailing arms TA1,TA2; and shock absorbers SA1,SA2 as shown, e.g., in FIGS. 1A and 2-4. The axle subassembly AS is connected to the frame subassembly FS which, in turn, operatively connects the axle L1 to the trailer chassis. In particular, the trailing arms TA1,TA2 are pivotally connected to the hangers H1,H2 by fasteners such as bolts U1,U2, respectively, (a bushing is typically used at the interface of the trailing arms TA1,TA2 with the hangers H1,H2). Also, the shock absorbers SA1,SA2 are pivotally connected at their upper ends to the hangers H1,H2 using bolts or other fasteners U3 and at their lower ends to the trailing arms TA1,TA2, respectively, using bolts or other fasteners U4. According to the present invention, the trailing arms TA1,TA2 are preferably constructed entirely from an aluminum alloy, such as from one or more extruded aluminum members. In one embodiment, first and second aluminum extrusions are welded together to define each trailing arm TA1,TA2.

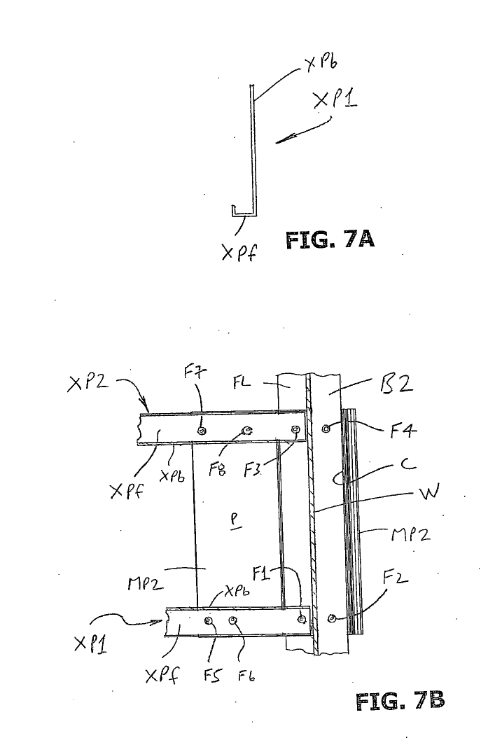

With particular reference now to FIGS. 5-8, which show the frame subassembly in full detail, it can be seen that the cross-plates XP1,XP2 are arranged transverse to the trailer longitudinal axis Y, preferably parallel to each other, and extend between and interconnect the beams B1,B2. The beams B1,B2 have an overall I-shaped profile with upper and lower flanges FU,FL connected by a web W. The cross-plates XP1,XP2 are fitted vertically between the upper and lower flanges FU,FL of the beams Bi,B2 and are fixedly secured to the beams B1,B2 by welding or fasteners or otherwise. With reference also to the sectional view of FIG. 7A, the cross-plate XP1 comprises a planar body XPb and a U-shaped lower flange XPf that sits on the lower flange FL of the beams B1,B2 (the cross-plate XP2 has the identical shape, but is preferably oriented in the opposite direction).

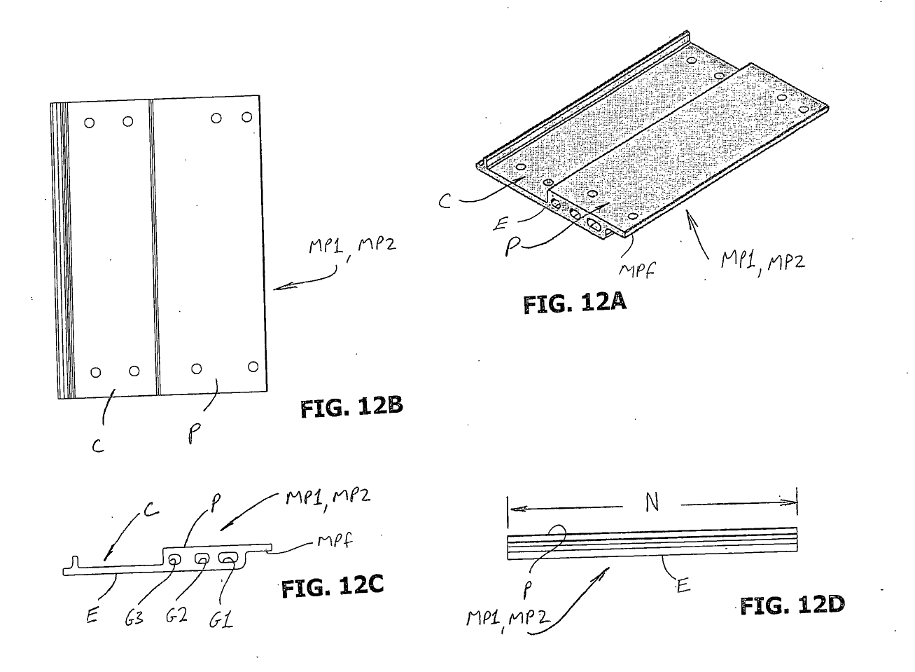

As shown in FIGS. 5-8 and as mentioned above, the frame subassembly FS includes the mounting plates MP1,MP2 that provide an interface for connecting the hangers H1,H2 to the beams B1,B2, respectively. The mounting plates MP1,MP2, which are also shown separately in FIGS. 12A-12D, are identical to each other but are arranged in an opposite, mirror-image fashion in the frame subassembly FS. Each mounting plate MP1,MP2 defines an upwardly opening U-shaped channel C that is conformed and dimensioned to receive a lower flange FL of the respective beams B1,B2 with minimal lateral clearance to prevent or at least minimize lateral movement of the mounting plates MP1,MP2 relative to the beams B1,B2 (i.e., movement transverse to the trailer axis Y). The mounting plates XP1,XP2 each define an axial length N extending parallel to the trailer axis Y that is at least equal to the axial spacing defined inclusively between the cross-plates XP1,XP2. The mounting plates MP1,MP2 each also comprise a raised platform P connected to and located adjacent the channel C. The platform P and channel C are preferably dimensioned and arranged so that a when the lower flange FL of the beams B1,B2 are fully seated in the channel C as shown in FIGS. 5-8, the platform P of each mounting plate MP1,MP2 abuts both cross-plates XP1,XP2, in particular, the lower flanges XPf of the cross-plates XP1,XP2.

With particular reference to FIG. 7B, which is a sectional view as taken along line B-B of FIG. 7, the mounting plate MP2 is secured to the lower flange FL of the beam B2 using a plurality of fasteners such as bolts F1,F2,F3,F4. The bolts F1-F4 extend vertically through the bottom wall of the mounting plate channel C and also through the lower flange FL of the beam B2 with two bolts F1,F3 located inside the beam web W and with two bolts F2,F4 located outside the beam web W (the illustrated example uses a rectangular bolt pattern). The inside bolts F1,F3 also extend through and engage the lower flanges XPf of the cross-plates XP1,XP2, respectively, to secure the cross-plates XP1,XP2 directly to the beam B2 and also to the mounting plate MP2. The mounting plate MP1 is secured to the beam B1 in the corresponding fashion as just described for the mounting plate MP2 and beam B2.

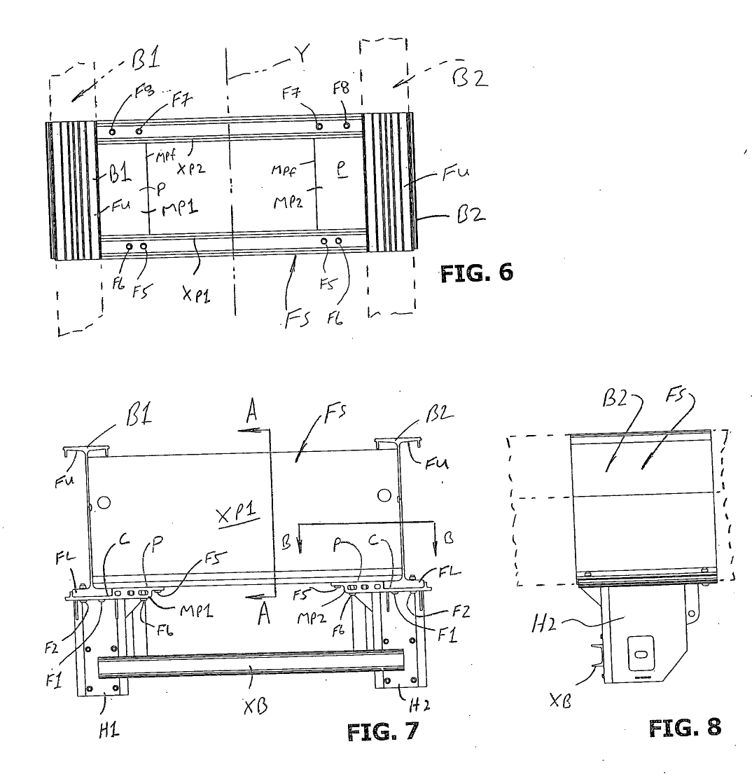

With continuing reference to FIG. 7B and also to FIGS. 6 and 7, the platforms P of the mounting plates MP1,MP2 are each connected to both cross-plates XP1,XP2 using fasteners such as bolts F5,F6,F7,F8. The bolts F5,F7 are laterally aligned with each other and extend through an outer lip or flange MPf of the mounting plates MP1,MP2. The bolts F6,F8 are laterally offset relative to each other, and are aligned with and pass through respective longitudinally extending hollow passages G1,G2 (see also FIG. 12C) of the mounting plates MP. The mounting plates MP1,MP2 also include a third longitudinally extending hollow passage G3. These hollow passages G1-G3 reduce the weight of the mounting plates MP1,MP2 and facilitate extrusion of same using aluminum alloy as described in full detail below. The offset nature of the fasteners F6,F8 prevents stress concentration in the region of one of the passages G1,G2.

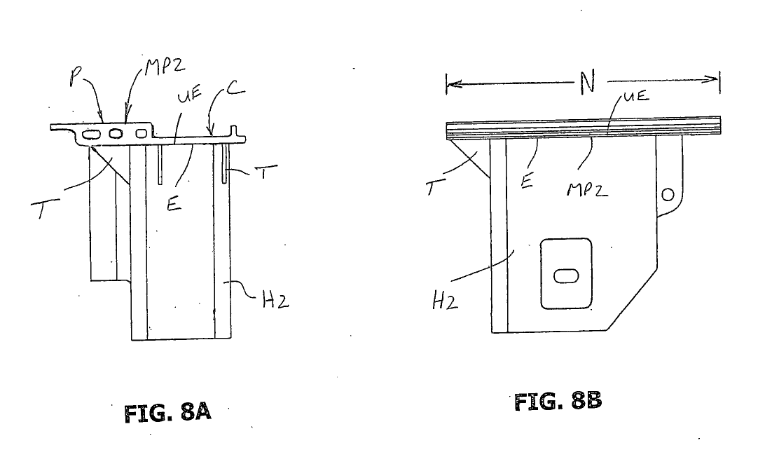

As noted, the mounting plates MP1,MP2 provide an effective interface for connecting the hangers H1,H2 to the beams B1,B2. In particular, as shown by example in FIGS. 8A and 8B with reference to the mounting plate MP2 and hanger H2, the hangers H1,H2 are fixedly secured to a lower face E of the mounting plates MP1,MP2, and the mounting plates MP1,MP2 are respectively secured to the beams B1,B2 as just described. The lower face E of the mounting plates MP1,MP2 is preferably planar, and the hangers H1,H2 are preferably fixedly secured thereto by welding, although other means for securing the hangers to the mounting plates can be used, e.g. bolts or other fasteners.

FIG. 1A and FIGS. 8A and 8B illustrate a preferred connection between the hangers H1,H2 and their respective mounting plates MP1,MP2. An upper edge UE of each hanger H1,H2 is abutted with the lower face E of its respective mounting plate MP1,MP2, and the hangers are welded to their respective mounting plates, preferably along the entire seam where the hanger edge UE abuts the surface E. A plurality of triangular support gussets T are used to reinforce the welded joint. FIGS. 8A and 8B show the hanger H2 connected to the mounting plate MP2, and those of ordinary skill in the art will recognize that the hanger H1 is connected to its mounting plate MP1 in a corresponding fashion as shown, e.g., in FIGS. 1A, 3 and 7.

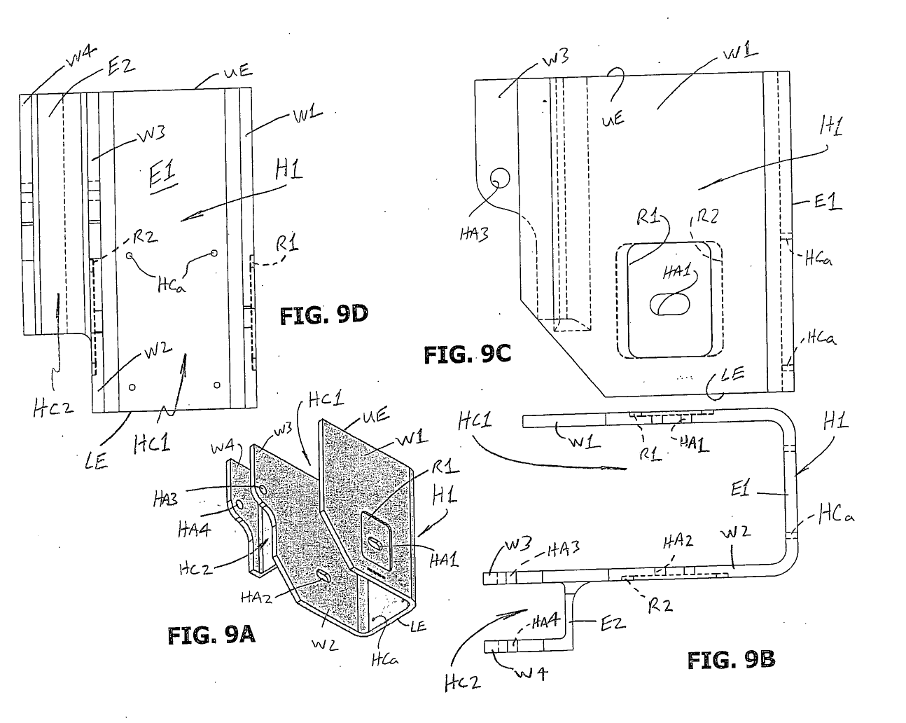

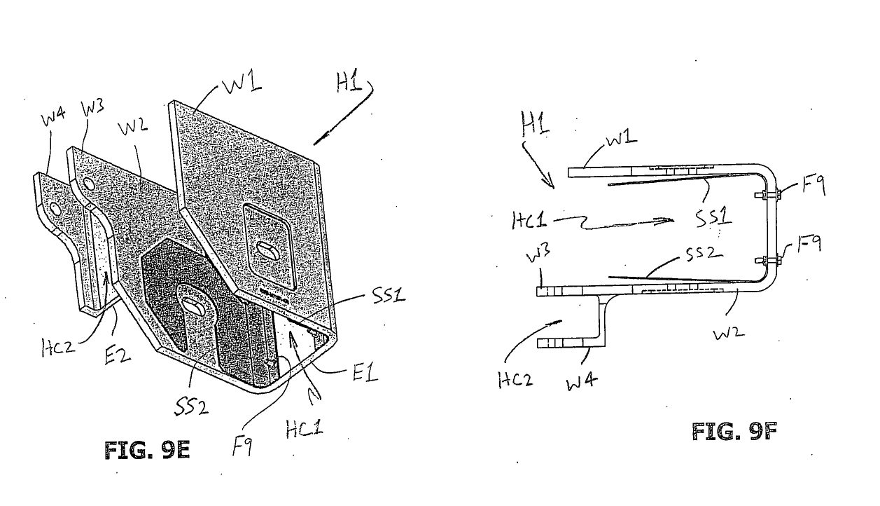

The hanger H1 is shown in full detail by itself in FIGS. 9A, 9B, 9C, 9D, 9E and 9F. The hanger H1 is defined as a one-piece construction from extruded aluminum alloy and comprises first and second U-shaped channels: (i) a trailing arm channel HC1; and (ii) a shock absorber channel HC2. The trailing arm channel HC1 is adapted for receiving an end of the trailing arm TA1 therein for pivoting connection of the trailing arm TA1 to the hanger H1 using the bolt and bushing structure U1 (as shown in FIG. 1A). The shock absorber channel HC2 is adapted for receiving the upper end of the shock absorber SA1 therein for pivoting connection of the shock absorber SA1 to the hanger H1 using the bolt or other fastener U3 (as shown in FIG. 1A). The trailing arm channel HC1 is defined by first and second parallel sidewalls W1,W2 interconnected by a first transverse end wall E1. The shock absorber channel HC2 is defined by third and fourth parallel sidewalls W3,W4 interconnected by a second transverse end wall E2. In the illustrated embodiment, the third sidewall W3 is defined by an extension of the second sidewall W2,W3. As shown, the sidewalls W2,W3 lie in the same plane, but the sidewall W3 can alternatively be defined by a laterally offset extension of the sidewall W2. The sidewalls W1,W2 define aligned elongated apertures HA1,HA2 for receiving the trailing arm connection bolt U1, and the sidewalls W3,W4 define aligned apertures HA3,HA4 for receiving the shock absorber connection bolt U3. The sidewalls W1,W2 also include respective machined recesses R1,R2 that encompass the apertures HA1,HA2, respectively. These recesses R1,R2 receive disc members D (see FIGS. 1A and 3) used for adjusting the position of the trailing arm TA1 (which requires that the apertures HA1,HA2 be elongated to accommodate axial movement of the bolt U1 therein). The upper edge UE of the hanger H1 is preferably smooth and uninterrupted to facilitate welding connection to the mounting plate MP1, and the hanger H1 also includes a lower edge LE which is located opposite the upper edge. The transverse end walls E1,E2 are arranged parallel to each other, but are axially spaced from each other. The end wall E1 of the trailing arm channel HC1 includes apertures HCa that receive fasteners F9 used for securing first and second stainless steel liners SS1,SS2 (FIGS. 9E,9F) in the channel HC1. The two separate liners SS1,SS2 can optionally integrated with each other into a one-piece component. These liners SS1,SS2 are typically installed as shown to prevent wear of the walls W1,W2 of the hanger H1 over time due to movement of the trailing arm TA1 in the channel HC1. The height of the hanger H1 defined between the upper and lower edges UE,LE is varied depending upon the desired/required ride-height for the suspension trailer suspension assembly.

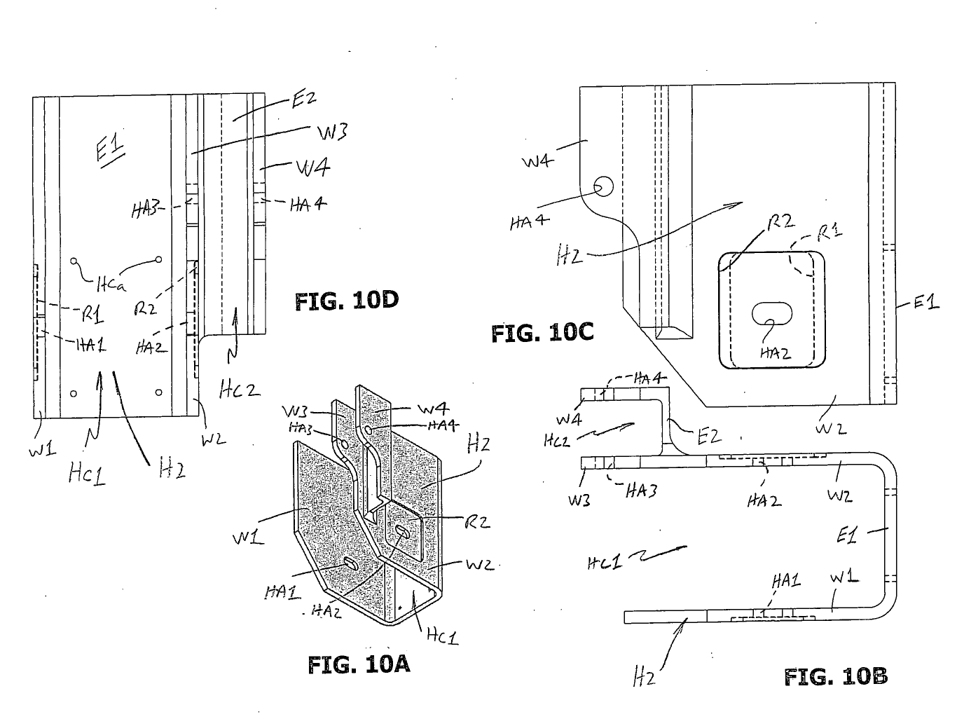

FIGS. 10A, 10B, 10C and 10D correspond to FIGS. 9A, 9B, 9C and 9D, but show the hanger H2. The hanger H2 is identical to the hanger H1, except that it has a mirror structure. As such, features of the hanger H2 are identified with the same reference characters used to identify corresponding features of the hanger H1, and those of ordinary skill in the art will appreciate that the hanger H2 connects to the trailing arm TA2 and shock absorber SA2 in a manner that corresponds to the connection of the trailing arm TA1 and the shock absorber SA1 to the hanger H1. The hanger H2 typically also includes stainless steel liners SS1,SS2 as are shown for the hanger H1 in FIGS. 9E and 9F and as detailed above.

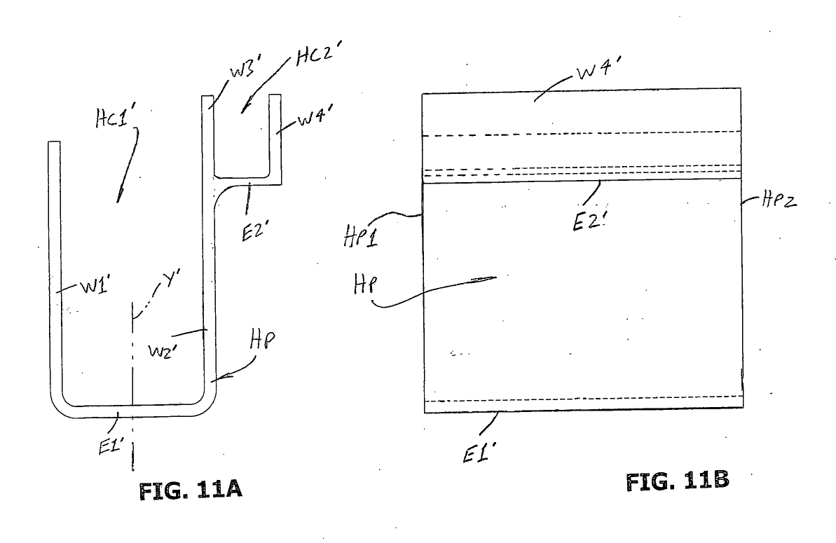

The hangers H1 and H2 are each preferably defined from a monolithic or one-piece extruded aluminum workpiece HP as shown in FIGS. 11A and 11B. The workpiece HP is extruded with the profile shown in FIG. 11A. There, it can be seen that the workpiece HP includes first and second parallel side walls W1′,W2′ interconnected by a transverse end wall E1′. These walls W1′,W2′,E1′ define an three-sided open channel HC1′. The workpiece HP further includes third and fourth side walls W3′,W4′ interconnected by a transverse end wall E2′. These walls W3′,W4′,E2′ define another three-sided open channel HC2′. The end walls E1′,E2′ are parallel to each other but spaced along the axis Z′, and the third side wall W3′ is defined as an extension of the second side wall W2′. The workpiece HP is cut from the extrusion so that it includes opposite ends HP1,HP2 spaced along the extrusion axis. The length of the workpiece HP between the opposite ends HP1,HP2 is varied as desired/required depending upon the desired height of the finished hanger H1,H2 as defined between the hanger upper and lower edges UE,LE.

The hangers H1,H2 are machined from a workpiece HP. If a hanger H1 is to be defined, the end HP1 is set to define or at least correspond to upper edge UE of the hanger H1, and the hanger H1 is then machined from the workpiece HP to have the shape disclosed above with reference to FIGS. 9A-9D, wherein the channels HC1′,HC2′ of the workpiece eventually define the channels HC1,HC2 of the finished hanger H1. Alternatively, if a hanger H2 is to be defined, the opposite end HP2 of the workpiece HP is set to define or at least correspond to upper edge UE of the hanger H2, and the hanger H2 is then machined from the workpiece HP to have the shape disclosed above with reference to FIGS. 10A-10D, wherein the channels HC1′,HC2′ of the workpiece eventually define the channels HC1,HC2 of the finished hanger H2.

The trailer beams B1,B2, the cross-plates XP1,XP2, the mounting plates MP1,MP2 and hangers H1,H2 are all preferably defined from a suitable aluminum alloy (sometimes referred to herein simply as “aluminum”) such as 6061-T6 or another suitable aluminum alloy. The trailing arms TA1,TA2 are defined from a steel alloy or from extruded aluminum as described above. It is most preferred that the mounting plates MP1,MP2 be extruded from the aluminum alloy material so that the extrusion has a profile as shown in FIG. 12C. This ensures that the mounting plates are monolithic or one-piece members. As just described, the hangers H1,H2 are preferably defined as one-piece extrusions of the aluminum alloy, beginning with the extruded workpiece HP of FIGS. 11A and 11B, which is then machined or otherwise worked to define the finished one-piece hanger H1 or H2. The cross-brace XB that is welded or otherwise secured to and interconnects the hangers H1,H2 is preferably also defined as an aluminum extrusion or other aluminum member. Depending upon the size, the beams B1,B2 can be extruded from the aluminum alloy to have the exact I-beam shape as shown in FIGS. 3 and 7 or, as shown, the beams B1,B2 are fabricated from first and second T-shaped oppositely oriented aluminum extrusions T1,T2 (FIG. 3), the bases of which are welded or otherwise fixedly secured (e.g., by welding) along a seam S in order to define the desired I-beam profile as shown. The cross-plates XP1,XP2 can be extruded with the profile shown in FIG. 7A or, if too big for extrusion, can be defined from a formed plate or plates of aluminum alloy such as the above-noted 6061-T6 aluminum alloy or another aluminum alloy that is bent or otherwise formed to the desired shape. The various bolts and other fasteners are defined from conventional steel, stainless steel, aluminum alloy or other materials as desired.

The development has been described with reference to preferred embodiments. Modifications and alterations will occur to those of ordinary skill in the art to which the development pertains upon reading this specification, and it is intended that the claims be construed as encompassing these modifications and alterations to the maximum possible extent.

1. A trailer suspension assembly comprising:
first and second spaced-apart trailer beams, said first and second trailer beams comprising respective first and second lower flanges;
at least one cross-plate extending between the first and second trailer beams;
first and second mounting plates connected to the first and second lower flanges, respectively, said first and second mounting plates also connected to said at least one cross-plate;
first and second hangers connected to the first and second mounting plates, respectively, said first and second hangers each comprising a trailing arm channel adapted to receive a trailing arm end and a shock absorber channel adapted to receive a shock absorber end.

2. The trailer suspension assembly as set forth in claim 1, wherein said first and second trailer beams, said at least one cross-plate, said first and second mounting plates, and said first and second hangers all comprise aluminum alloy.

3. The trailer suspension assembly as set forth in claim 2, wherein:
said first trailer beam comprises two oppositely oriented T-shaped aluminum extrusions that are fixedly secured to each other to define said first trailer beam as a first I-beam comprising said first lower flange;
said second trailer beam comprises two oppositely oriented T-shaped aluminum extrusions that are fixedly secured to each other to define said second trailer beam as a second I-beam comprising said second lower flange.

4. The trailer suspension assembly as set forth in claim 1, wherein said at least one cross-plate comprises first and second spaced-apart cross-plates that extend between said first and second trailer beams, and wherein said first and second mounting plates are each connected to both said first and second cross-plates.

5. The trailer suspension assembly as set forth in claim 4, wherein:
said first and second mounting plates comprise respective first and second one-piece aluminum extrusions each comprising: (i) an upwardly opening channel; (ii) a platform located adjacent the channel; and, (iii) a lower face;
said first lower flange of said first trailer beam is seated in said channel of said first mounting plate;
said second lower flange of said second trailer beam is seated in said channel of said second mounting plate;
said platforms of both said first and second mounting plates are abutted with and connected to both the first and second cross-plates; and,
said first and second hangers are connected to the lower faces of the first and second mounting plates, respectively.

6. The trailer suspension assembly as set forth in claim 5, further wherein:
said first and second mounting plates are secured to said respective first and second lower flanges by a first group of fasteners;
said first and second mounting plates are secured to said first and second cross-plates by a second group of fasteners.

7. The trailer suspension assembly as set forth in claim 6, wherein:
said first mounting plate is secured to both said first lower flange and said first and second cross-plates by a third group of fasteners;
said second mounting plate is secured to both said second lower flange and said first and second cross-plates by a fourth group of fasteners.

8. The trailer suspension assembly as set forth in claim 2, wherein said first and second mounting plates are each defined as a one-piece aluminum extrusion.

9. The trailer suspension assembly as set forth in claim 8, wherein said first and second mounting plates each comprise axially extending hollow passages.

10. The trailer suspension assembly as set forth in claim 1, wherein said at least one cross-plate comprises a planar body and flange, wherein said flange of said at least one cross-plate is abutted with said respective first and second lower flanges of said first and second trailer beams.

11. The trailer suspension assembly as set forth in claim 1, wherein said first and second hangers comprises respective one-piece aluminum hanger extrusions.

12. The trailer suspension assembly as set forth in claim 11, wherein said first and second mounting plates comprise respective one-piece aluminum mounting plate extrusions, wherein said first and second hanger extrusions are welded to said first and second mounting plate extrusions.

13. The trailer suspension assembly as set forth in claim 1, wherein said first and second hangers each comprise at least one stainless steel liner located in said trailing arm channel.

14. The trailer suspension assembly as set forth in claim 1, further comprising an aluminum cross brace that extends between and interconnects said first and second hangers.

15. A trailer suspension subassembly comprising:
an extruded aluminum mounting plate;
an extruded aluminum hanger connected to a lower face of said mounting plate, said hanger comprising a trailing arm channel and a shock absorber channel;
wherein said mounting plate comprises an open channel adapted to receive a trailer beam flange and a platform adjacent said open channel.

16. The trailer suspension subassembly as set forth in claim 14, wherein said platform is elevated relative to a bottom wall of said open channel.

17. The trailer suspension subassembly as set forth in claim 14, wherein said hanger is welded to said lower face of said mounting plate.

18. The trailer suspension subassembly as set forth in claim 15, further comprising a trailing arm having an end located in said trailing arm channel and pivotally connected to said hanger, wherein said trailing arm is defined by a plurality of interconnected extruded aluminum components.

19. A hanger mounting plate for a trailer suspension, said hanger mounting plate comprising:
a one-piece extruded aluminum member comprising: (i) an upwardly open channel adapted to receive an associated trailer beam flange, said channel having a bottom wall; (ii) a platform located adjacent said channel and elevated relative to said bottom wall; and, (iii) a lower face adapted for being connected to an associated suspension hanger.

20. The hanger mounting plate as set forth in claim 19, wherein a plurality of hollow channels extend through said mounting plate, wherein said hollow channels are parallel to each other and extend parallel to an axis along which said open channel and platform extend.
